(19) United States
(12) Patent Application Publication
(10) Pub. No.: US 2010/0325686 A1
(43) Pub. Date: Dec. 23, 2010

(54) DYNAMIC ACCESS CONTROL LISTS

(75) Inventors: Marc E. Davis, San Francisco, CA (US); Chris W. Higgins, Portland, OR (US); Simon P. King, Berkeley, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/489,965

(22) Filed: Jun. 23, 2009

(51) Int. Cl. H04L 29/06

(52) U.S. Cl. 726/1

(57) ABSTRACT

Disclosed are methods and apparatus for creating and managing dynamic access control lists (ACL's). In a specific embodiment, a method of creating or modifying a dynamic access control policy (ACP) is disclosed. A current ACP for one or more specified resources is defined based on one or more membership rules for specifying users who can access the one or more specified resources based on user information that was or will be collected for a plurality of users. The collected user information includes at least user presence information or user communication data. The current ACP is retained for the one or more specified resources, wherein the current ACP is accessibly usable so as to dynamically allow a selected set of users, who each have corresponding collected user information which meets the one or more membership rules of the current ACP, to access the one or more specified resources. The selected set of users is changeable over time as different user information is collected over time.

### BACKGROUND OF THE INVENTION

The present invention is related to techniques and mechanisms for providing access control for computer resources, such as media objects.

Traditional access control systems use manually maintained Access Control Lists (ACL's) and rigidly define the protected resources, usually by describing their storage location (e.g., a UNIX file system directory). For example, particular user groups may be given access to a particular file system directory. Although these ACL's can provide useful mechanisms for controlling user access, there continues to be a need for improved mechanisms for creating and utilizing ACL's.

### SUMMARY OF THE INVENTION

In certain embodiments, mechanisms for creating and managing dynamic access control lists (ACL's) have been disclosed. In a specific embodiment, a method of creating or modifying a dynamic access control policy (ACP) is disclosed. A current ACP for one or more specified resources is defined based on one or more membership rules for specifying users who can access the one or more specified resources based on user information that was or will be collected for a plurality of users. The collected user information includes at least user presence information or user communication data. The current ACP is retained for the one or more specified resources, wherein the current ACP is accessibly usable so as to dynamically allow a selected set of users, who each have corresponding collected user information which meets the one or more membership rules of the current ACP, to access the one or more specified resources. The selected set of users is changeable over time as different user information is collected over time.

In a specific implementation, the one or more membership rules each specify one or more of the following: a user type, a user location, or a time, and wherein the one or more membership rules specify at least one conditional operator. In a further aspect, the user type is specified by one or more other rules. In yet a further aspect, the user type specifies a category of social relationship with respect to the first user.

In another embodiment, the specified resources are defined by one or more resources rules for specifying which selected set of resources is accessible based on the specified one or more membership rules of the current ACP, and the selected set of resources is changeable over time as different resources are created or modified over time. In a further aspect, the one or more resource rules each pertain to one or more of the following contexts: creation, publication, annotation, interaction, or consumption. In this aspect, the one or more resource rules each specify one or more of the following: a resource type, a location, a user, or a time, and the one or more resource rules specify at least one conditional operator. In another embodiment, the current ACP for the one or more specified resources is defined automatically based on one or more other ACP's for one or more other resources that have similar characteristics as the one or more specified resources.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of certain embodiments of the invention and the accompanying figures which illustrate by way of example the principles of the invention.

### BRIEF DESCRIPTION OF THE DRAWINGS

FIG. 1 illustrates an example network segment in which the present invention may be implemented in accordance with one embodiment of the present invention.

FIG. 2 is a flow chart illustrating an access control policy (ACP) management process in accordance with one embodiment of the present invention.

FIG. 3 is a flow chart illustrating a membership rule management procedure in accordance with a specific implementation of the present invention.

FIG. 4 is a flow chart illustrating a procedure for managing dynamic resource rules in accordance with a specification implementation of the present invention.

FIG. 5A illustrates a user presence table in accordance with one embodiment of the present invention.

FIG. 5B illustrates a communication table in accordance with one embodiment of the present invention.

FIG. 5C illustrates a resource table in accordance with one embodiment of the present invention.

FIG. 6 is a flow chart illustrating a procedure for creation of an ACL in accordance with an alternative embodiment of the present invention.

FIG. 7 illustrates an example computer system in which specific embodiments of the present invention may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that they are not intended to limit the invention to one embodiment. On the contrary, they are intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Certain embodiments of the present invention provides mechanisms for using rules to set criteria for dynamically defining an access control list (ACL), as well as dynamically defining resources, so as to shift ongoing ACL maintenance to a one-time task of setting ACL conditions. Additionally, this method of setting dynamic ACL policy can allow dynamic ACL's to be set up “in advance”. That is, people who are not yet users of a given system can be automatically added to a dynamic ACL at a future time when they meet the dynamic ACL criteria. Conversely, users can be automatically excluded from an ACL for a particular set of resources when their user information changes such that they no longer meet the ACL requirements for such set of resources. In general, dynamic ACL and/or resource criteria can be defined by a set of conditional operators (e.g., Boolean operators) that are applied to user information, such as user presence or communication data, as well as resources, as further detailed below.

Although particular example uses of dynamic ACL's for accessing particular types of resources are described below, dynamic ACL's can be utilized for any suitable application. Additionally, although the following mechanism for creating and managing dynamic ACL's are described as being based on specific types of user information, such as presence or communication data, other types of user information may be used to form dynamic ACL's. Although the following ACL's definitions are described mainly in terms of users who meet each particular criteria (such as place and time criteria), ACL's may also be defined in other ways, such as a list of people who meet a time criteria for a particular place criteria, as people who were in Sunnyvale, Calif. three times last week. This last ACL example builds a 2^{nd} order membership time criteria from the base criteria (“been in Sunnyvale, Calif.”).

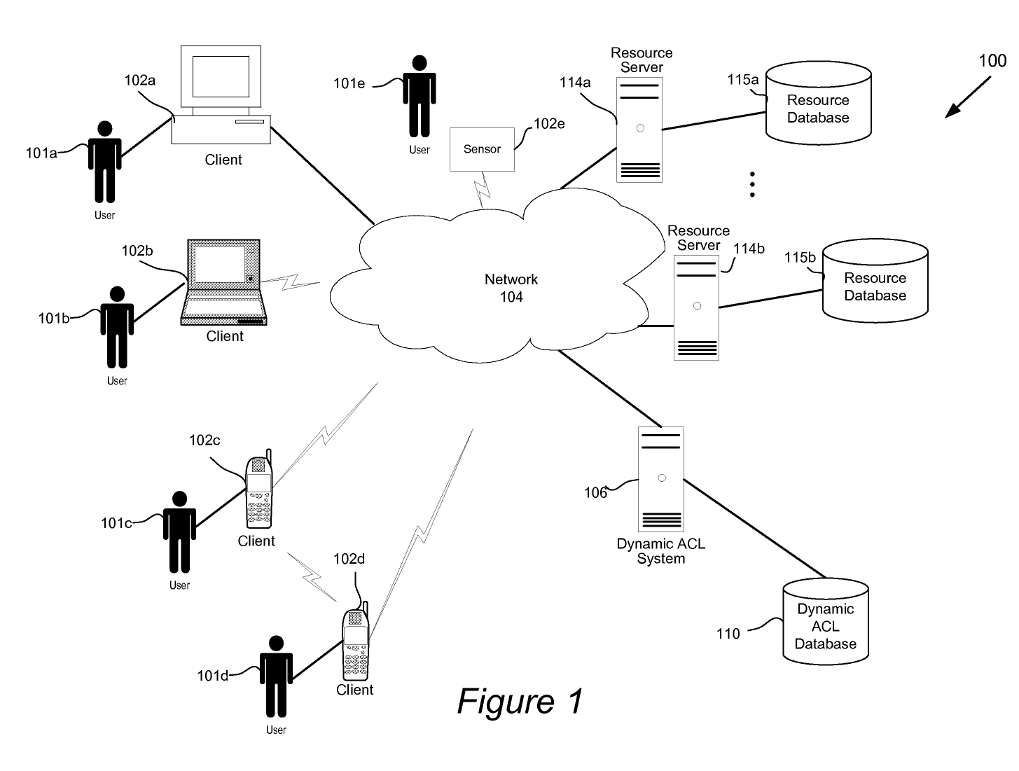

Prior to describing detailed mechanisms for creating and managing ACL's, a computer network architecture will first be briefly described to provide an example context for practicing techniques of the present invention. FIG. 1 illustrates an example network segment 100 in which the present invention may be implemented in accordance with one embodiment of the present invention. As shown, a plurality of clients 102a˜e may access various servers, for example, resource servers 114a or 114b or dynamic ACL server 106 via network 104. Each server (e.g., 114a, 114b, 106) may have access to one or more web database(s) (e.g., 115a, 115b, or 110) into which information is retained.

The network may take any suitable form, such as a wide area network or Internet and/or one or more local area networks (LAN's). The network 104 may include any suitable number and type of devices, e.g., routers and switches, for forwarding requests from each client to a particular server application, forwarding application results back to the requesting clients, or forwarding data between various servers.

Embodiments of the present invention may also be practiced in a wide variety of network environments (represented by network 104) including, for example, TCP/IP-based networks (e.g., Rate Control Protocol or RCP, Transport Control Protocol or TCP, Fast TCP, Stream-based TCP/IP or STCP, eXplicit Control Protocol or XCP, etc.), telecommunications networks, wireless networks, mobile networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A resource server may take any suitable form for storing or accessing any suitable resources. For examples, users may access resources based on dynamic ACL's as described further herein. Additionally, resources may take the form of a variety of user information, e.g., related to users 101a˜e, that may be tracked and retained for later use by a dynamic ACL generator, such as server 106, to determine whether such users can access other resources, such as photographs or files, etc. Additionally, user information may itself be a resource which is accessed based on a dynamic ACL.

In one implementation, a resource server takes the form of a communication server that is configured to implement a communication application, such as email, instant messaging, IP telephony, etc. A communication application generally allows a user (human or automated entity) to communicate with one or more other users via a communication device (e.g., telephones, persona digital assistants or PDA's, computers, etc.) via one or more networks (e.g., 104) and retain user communication information, for example, in database 115a. Embodiments of the present invention may be employed with respect to communication data obtained from communication server applications or generated from any communication application, such as general communications applications that include Yahoo! Email, Yahoo! IM, Facebook chat, etc. The communication applications may be implemented on any number of servers although only two resource servers 114a and 114b are illustrated for clarity and simplification of the description.

In another example implementation, a resource server may take the form of a presence server that is configured to implement a mechanism for retaining presence information regarding, for example, a plurality of registered users, e.g., in database 115b. Presence data may include such user's locations during specific times as explained further below.

Embodiments of the present invention may include a dynamic ACL system or server 106 for creating and managing dynamic ACL's (or dynamic access control policies for both ACL's and resources). The dynamic ACL system may be implemented within another application server, such as a resource server 114a or 114b or on a separate server, such as the illustrated dynamic ACL system 106. In general, the dynamic ACL system is configured to allow the creation and management of dynamic ACL's based on predefined rules or policies. The dynamic ACL system 106 may access one or more dynamic ACL databases, e.g., dynamic ACL database 110, for storing ACL policies and rules, ACL's, etc.

The dynamic ACL system 106 may also be configured for various other related tasks, such as managing the privacy rights of users. For example, dynamic ACL system 106 may provide privacy control for the user information that can be accessed and used to form ACL's. By way of example, a user may not want presence information for particular venues (e.g., a strip club) to be accessed and used to form ACL groups. In one embodiment, each user can configure one or more access models for specifying which user data (e.g., presence or communication data) may be accessed for (or excluded from) use in dynamic ACL formation techniques.

User information for use in dynamically forming ACL's may be collected in any suitable manner. For example, a user may self-report user information and/or user information may be automatically collected as the user interacts with the computer network or various networked devices, which are equipped with automatic self-reporting features. In one implementation, each user registers (e.g., with dynamic ACL system 106) to participate in ACL's. Users can register at any time, even after certain ACL policies have been defined. During registration (or at a later time), a user may supply various user information, such as contact information, interests, occupation, family information, etc.

After user registration, user data may also then be periodically collected from the registered user as further described below. For example, presence data for each user may be periodically collected as each user changes his/her location. The collection of user data may be triggered by any suitable event. In one implementation, user data that pertains to specific user activities may be collected when users perform such specific activities or perform a predefined threshold of such specific activities.

Data relating to the user location can be obtained from a variety of sources including humans and devices such as cellular telephones, mobile computing or gaming devices, appliances or vending machines, private or public vehicles, private or public buildings and sensors. Location data could be provided by the user or the user's device. For example, a user may engage in various online activities that can provide location data. For example, a user may belong to one or more user websites, such as a social networking website (e.g., Facebook website) or a microblogging site (e.g., the Twitter website). Personal blogs or websites may also contain content created or annotated by the user and published on an interconnected network for consumption and enjoyment by other users. The user's online activities, such as what web sites are visited, how long each website is visited, and what the user clicks on or interacts with (e.g., via a pointing device, such as a mouse or cursor) may also be traced and stored by the user, a network, or third-party service provider. A user may explicitly post a status message to such sites indicating his or her current location or an intended destination or series of locations and associated times of expected presence (which could be remote in time.) A user may also send emails indicating the user's current location or intended destination as well as communicated interactively through speech or IM in real-time with other users such that all of these channels may be sources of data regarding user location or destination including weighting the reliability of specific data instances or values based upon entity extraction from communications before, during or after the location/time data seeking to be verified. Of course, a user may also be able to directly post a stated location for the service to use via, for example, a webpage or a text message.

Location data could be obtained from communications networks. In the illustrated example, users 101c and 101d may both have phones 102c and 102d connected to a mobile network such as a CDMA or GSM network. One of these users may also have a Personal Data Assistant (PDA) that is communicatively connected to a wireless network. The position of the user's devices 102c and 102d could be determined or approximated using any conventional technique such as triangulation of cell signals or the location of the nearest cell tower. The user devices 102c and 102d could also include other sensors, such as GPS sensors, which could provide a relatively precise geographical position as well as biometric or orientation-in-space data. Successive sets of data could be analyzed to determine a real-time rate and direction for any motion as well as to establish individual, archetype user, and aggregated user patterns and trends, which becomes valuable data in weighting the reliability of future location data instances.

Location data could be obtained from sensor networks. In the illustrated example, user 101e is within the sensing radius of one or more sensors 102e. The sensors 102e could be any kind of sensor capable of identifying an individual with a reasonable degree of accuracy including but not limited to RFID tag readers, biometric sensors, motion sensors, temperature or weather sensors, access sensors, security sensors or multimedia stream sources including real-time feeds from on scene users with multimedia streaming or capture enabled devices, appliances, vehicles, buildings, etc. For example, the sensors 102e could be any kind of biometric sensors, such as a facial recognition system or a fingerprint scanner. The sensors 102e could be scanning devices for user identification credentials, such as a driver's license. The sensors could be RFID sensors that sense RFID devices associated with a user through, for example, a user device such as a cell phone 102c or laptop 102b, in which an RFID device is embedded. Other known types of objects or people, in which RFID devices may be embedded, include people, clothing, vehicles, jewelry and child or elderly protection or monitoring devices.

Location data for one user could be provided by another user. For example, user 101a could provide a stated location for another user. For example, user 101a could post a status message to a website or send an email that indicates user 101c is, or will be, in a specific place at a specific time. One user's device could recognize the presence of another user's device in a given location. For example, a PDA 102c of user 101c, could use a short range communication protocol such as the Bluetooth protocol, to detect and recognize that cellular phone 102d of user 101d is within range of the PDA and transmit such information to the presence server 114a through one or more networks 104. A user device could be used to request a user to explicitly verify the presence of another user in a given location. For example, a presence server, e.g., 114a, could send an inquiry to user 101a via a text message, an email or an instant messages requesting user 101a to verify that user 101b is in a given location or co-present with one or more additionally specified users or objects.

Location data could also be provided through one or more third party location data providers. This mechanism may be used under circumstances where location data cannot be directly obtained from a communications or sensor network, such as foreign jurisdictions which strictly control location data for privacy or national security reasons. Location data may also be obtained from local area sensor networks, such as video feeds, local wifi or other presence or identity enabled processes, appliances or devices that sense and record users and/or their activities at one or more locations. For example, a theme park or access-controlled home owners association gathers data on users and their locations, their comings and goings, which may then be offered in real-time or post-event to others on a free or fee-basis.

Mechanisms may also be employed for verifying collected user data (e.g., verifying that user presence data is accurate). That is, only collected user data that meets a predefined reliability specification can be used to dynamically allow selected users to become members of an ACL (e.g., based on a membership policy for such ACL). For example, collected user information that is deemed as unreliable may be excluded from being used to form ACL's. In one embodiment, reliability of a given user, sensor or user information may be determined on a typological basis, on an empirical basis or both. A user may be assigned to one or more types or archetypes based on any number of factors that describe the user. Such factors may include demographic factors such as age, nationality, gender, income, wealth, educational level and profession. Such factors may include the user's interests such as a favorite type of music, literature, hobby or other activities. Such factors may include metrics about the user's behavior on the Internet, such as the number of social networking websites the user is a member of, the number and frequency status messages posted by the user, the number of emails sent by a user, original content or content annotations published by the user, and so forth.

As a presence system accumulates data, it may become obvious that certain types of users and/or devices are reliable sources of location data. For example, users between the age of 25-35 with graduate degrees who post status messages to social networking or microblogging services 10 times per day may be more reliable sources of location data because their regular supplying of explicit location data provides a more reliable path through space time of their actual locations than users who provide or create less explicit location data. On the other hand, users over the age of 55 who rarely or never send emails, instant messages or post status messages may be less reliable sources of information. In all cases, a user's co-location with a device such as a cellular telephone or computing device that has a passive sensing capability enables a means to track their location implicitly without any need for status or location updates explicitly from the user.

When a user first becomes known to a presence tracking service, the user could be assigned a default reliability score, or, alternatively, could be typed by one or more factors associated with that user and assigned an initial reliability based on such a type. For example, users who regularly shut off their devices or who have a history of post event editing of their location data may be given a lower reliability score based upon their explicit attention to passive location data being gathered on them and/or an established pattern of falsifying or editing passively gathered location data. Reliability may also relate to the number and sophistication of sources. For example, a user with three co-present mobile devices gathering passive location data is far more reliable than a user with only one such device. Uses with GPS-enabled devices may be found to be more reliable than those with only cell-tower level location granularity.

After a sufficient amount of presence data is accumulated regarding a user, it may be possible to determine the reliability of a user as a source of location data empirically, which is to say, on the basis of data alone. Thus, for example, a user who is typologically within a group that is generally considered to be reliable, may be found to be unreliable. For example, a user between the age of 25-35 with a graduate degrees who posts status messages to social networking or microblogging services 10 times may habitually post misinformation regarding his or her location or lends his or her mobile devices to other users.

A sensor may be assigned to one or more types based on any number of factors that describe the sensor. Such factors may include basic types of technology, such as GPS sensors, RFID sensors, short range wireless sensors using protocols such as the Bluetooth protocol, or biometric sensors. Such factors may include the sensor's brand, or model number, or whether the device is running trusted client software or untrusted client software. When a sensor first becomes known to a presence tracking service, the sensor could be assigned a default reliability, or, alternatively, could be typed by one or more factors associated with that sensor and assigned an initial reliability based on such factors.

After sufficient amount of presence data is accumulated regarding a specific sensor, it may be possible to determine the reliability of the sensor as a source of location data empirically. Thus, for example, a sensor that is typologically within a group that is generally considered to be reliable may be found to be unreliable. For example, a GPS sensor may be considered to be generally reliable, but a given user's device may contain a GPS sensor that is defective or whose operation is impaired by the device in which it is embedded.

As user data is collected (and optionally verified), for example, by presence and communication servers, such user information can then be used as criteria for user membership in various ACL's. For example, an ACL for test data results may defined as “employees may only access test result data while on campus.” In another example, an ACL may be dynamically defined as “family” for accessing a resource that is defined as “photos I take at my house”. In these examples, even the definitions of “employee” and “family” may be based on dynamic rules as described further herein.

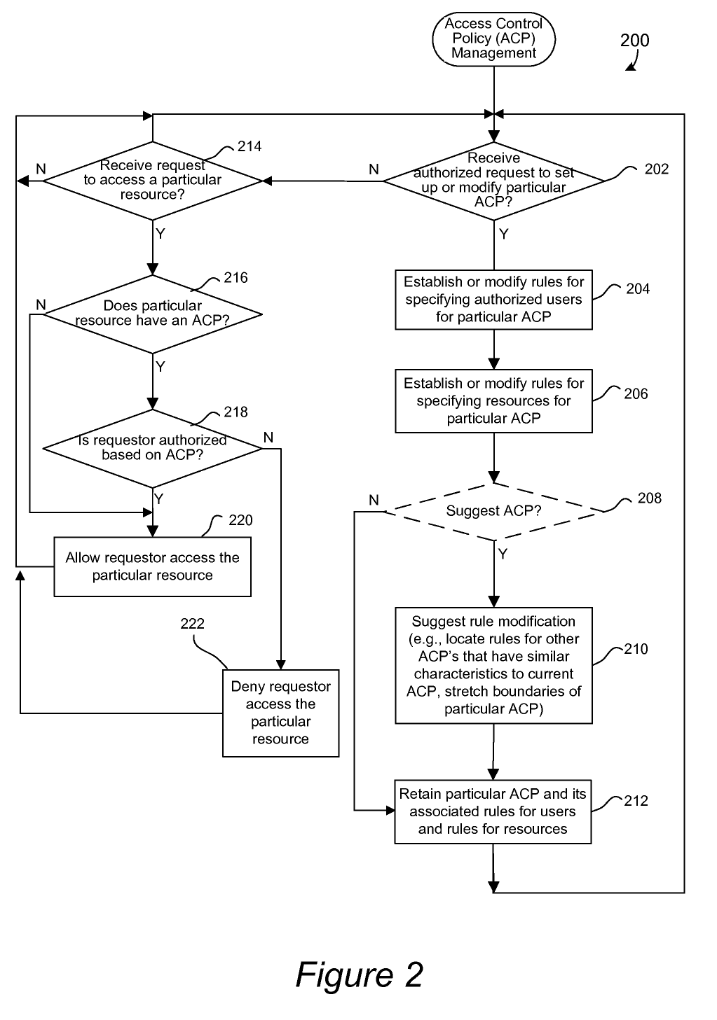

Mechanisms for creating and managing dynamic ACL's can be implemented in any suitable manner. FIG. 2 is a flow chart illustrating an access control policy (ACP) management process 200 in accordance with one embodiment of the present invention. The following procedure may be implemented with respect to any number and type of dynamic ACL and/or resources. For example, one or more users may make a request to create and/or modify a diverse number and type of ACL or resources policies having differing criteria. An ACP request to set up or modify an ACP may alternatively be performed automatically based on any suitable trigger event. In one embodiment, when a new resource is created or modified, an ACP for such new resource may be automatically requested and then formed based on one or more ACP's of similar one or more other resources. For example, the historical performance of a particular user or across all users with the same kind of object or resource may be used to automatically create or suggest an ACP of a particular object as further described herein.

Referring to the illustrated example, it may initially be determined whether an authorized request to set up or modify an ACP has been received in operation 202. For example, a user may send a request to form or modify a particular ACP to dynamic ACL server 106. Each new ACP may be associated with a unique name for referencing such new ACP and a unique user identification that corresponds to the user who is creating such ACP. A particular user may be identified by any suitable identifier, such as by one or more cookies (or other identifying information) that are associated with a user during a login process or by the user's particular client device identity (although not as reliable since multiple users may use a same client device or a user may use multiple client devices at various times).

Any user may be given authorization to create an ACP. However, a creator of a particular ACP may be the only person who is authorized to modify such particular ACP. Alternatively, the ACP's creator may delegate modification authority to one or more users. A user may be authorized to modify an ACP in a limited manner. For example, a user can be authorized to modify the ACP so that the membership ACL is only expanded and not contracted so as to exclude people who were already on the ACL. In another example, a user may be authorized to modify an ACP in any manner that does not result in the creator being excluded from such ACP. These various rights for how a user can modify a particular ACP (or who can modify a particular ACP) may be retained and associated with the particular ACP, for example, in the form of a rights model. User identifiers for users who have modified a particular ACP may also be retained so as to provide an audit trail, for example, to determine whether a user has unacceptably modified an ACP (e.g., allowed too many users to access a particular resource).

If a request to set up or modify an ACP has been received, rules for specifying authorized users for the current ACP may be established or modified in operation 204. Rules for specifying resources for the current ACP may also be established or modified in operation 206. Mechanisms for establishing or modifying rules for an ACP are further described herein. In general, any suitable criteria may used by an ACP creator (or modifier)—human or automated entity—to dynamically define an ACL and/or resource. For example, users that meet certain defined requirements with respect to their presence or communication data are given ACL membership for a particular defined resource.

An ACP may also be suggested during this procedure, for example in operation 208. If an ACP is to be suggested, a rule modification may be suggested in operation 210. Otherwise, this operation is skipped. Any number and types of rules may be suggested to the requester. For example, rules for other ACP's of other resources that have similar characteristics to the current ACP's established or modified rules may be located and suggested to the requester. In a specific example, the context of another resource may be similar to the context of the current resource, and such other resource's ACP may then be suggested for use with the current resource. In another example, it may be suggested that the boundaries of particular ACP's rules be stretched (e.g., incrementally).

The current ACP and its associated rules for users and rules for resources may then be retained in operation 212. For example, the requester's rules that have been established or modified for the particular ACP, as well as any selected suggested rules, are retained in association with such particular ACP. The ACP management procedure 200 may then repeat.

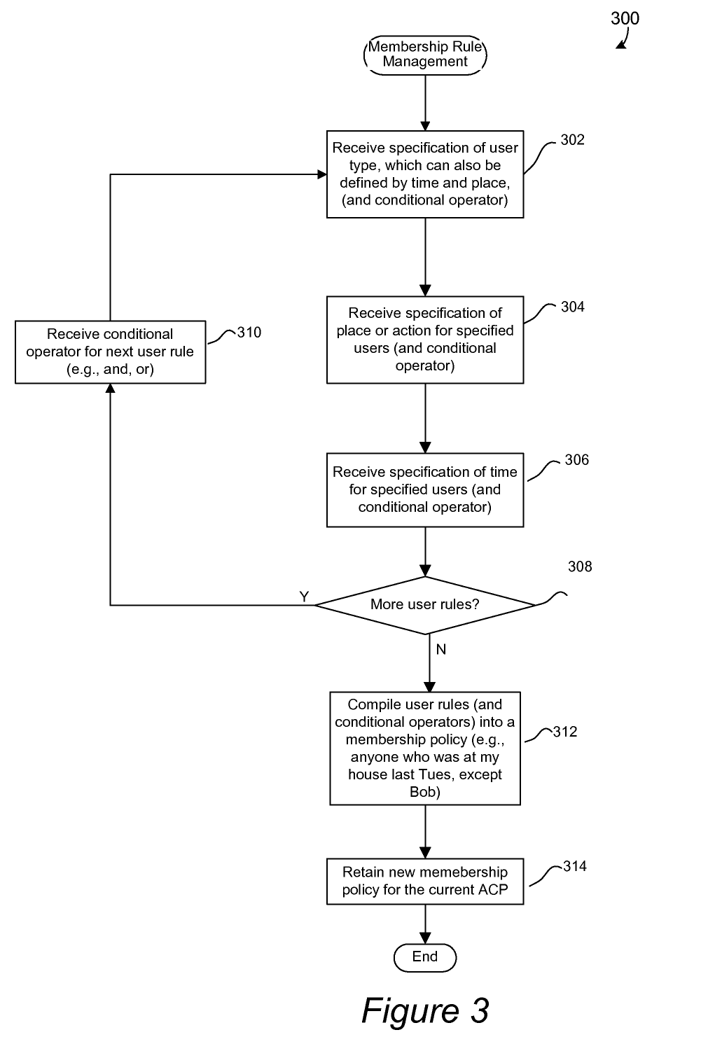

Membership rules and policy for a particular ACP may be defined using any suitable mechanism. FIG. 3 is a flow chart illustrating a membership rule management procedure 300 in accordance with a specific implementation of the present invention. In general, this membership procedure 300 may include a mechanism for a user to specify a user policy with respect to a particular ACP although such procedure may be applied to any suitable number of ACP's. Initially, a specification of user type (and optionally a conditional operator) for a current rule may also be received (from a user 102a by the dynamic ACL system 106) in operation 302. For example, a user type may be specified simply as anyone or no one. More specifically, the current rule or group policy may specify that everyone or no one is allowed to be a member of the current group. A user type may also specify a particular user, such as Bob or a specific category of social relationship with respect to the creator of the current group. Some example social relationship categories may include family, friends (close friends, college friends, high school friends, drinking buddies, acquaintances, etc.), coworkers, etc. A conditional operator may also be specified for the particular user type. For example, a conditional operator may include “not”, “except”, etc. For instance, the current rule specifies “not Bob” or “except Bob” for the current group.

A user type may itself be defined by a rule. In one implementation, a user type may be defined by users who meet specific place, time, and/or activity requirements. For example, an ACP creator may specify the user type “family” to be defined as “a user who is present within the rule creator's home every night or is present in the rule creator's home more than a predetermined percentage (e.g., 50%) of time.” In this example, user category “family” may dynamically change as more children join the family. In another example, a user category “close friends” may be defined as “people who I contact at least once per week or people I meet at least once a week.” These user category definitions can be generally based on a history of user actions. Other user types may include defined categories of users who have particular interests, such as cars, photography, politics, movies, television shows, etc.

A criteria type (e.g., user type) that is selected as part of a rule may also trigger a mechanism for locating other rules or criteria to present to a user as suggestions. For example, other users may have alternative ways to define “family”, which may be presented to the current user who is establishing or modifying a group policy. In another example, a most common family definition may be presented to the current user. The suggestions may also be used to automatically form an ACP for a particular resource without human intervention.

A specification of place or action (and conditional operator) for the specified users may also be received in operation 304. A particular place or geographical region (e.g., was at my house, was not at my house, lives in San Francisco, was present in San Francisco) may be specified for the current rule. User actions may include people who share resources (e.g., photos) or user information with me, and such user actions may be used to define a group policy for reciprocal sharing of similar resources or user information, for example. User actions may also include communication actions. For example, communication actions may pertain to the method of contact (e.g., person has emailed me, person has phoned me), the particular device (e.g., cell phone, home phone, computer, etc.) that was used for the communication, or the particular contact address (e.g., at my college or work email).

The specification of time (and conditional operator) for the specified users may also be received in operation 306. For example, people who were at my house last Tuesday anytime, this week, or during Christmas week may be specified for the current rule.

It may then be determined whether there are any more user rules (for the current group) in operation 308. If there are more rules, a conditional operator for the next user rule may then be received in operation 310. For example, the conditional operator may be in the form of a Boolean operator (e.g., except, and, or, not, etc.). The procedure for setting up a user rule may then be repeated in operations 302 through 306.

When there are no more user rules to be specified for the current ACP (the user indicated that he/she is has finished the user rule creation or modification process), the user rules (and conditional operators) may then be compiled into a membership policy in operation 312. For example, the membership policy may now specify “anyone who was at my house last Tuesday, except Bob.” This example membership policy includes a first rule that specifies a person (anyone), a place (my house), and a time (last Tuesday), and a second rule that specifies a single user Bob, with a conditional operator “except” being applied for the 2^{nd} rule. In general, one or more specified rules and their respective criteria may include a conditional operator. After a membership policy is compiled, it may also be retained for the current ACP in operation 314, and the membership rule management procedure 300 ends for the current ACP. However, an authorized user may modify a particular membership policy at any suitable time.

Rules or criteria for a particular resource may also be specified for a particular ACP in any suitable manner. Alternatively, one may simply specify a specific resource or set of resources (e.g., specify file locations) for a particular ACP. In this later example, the resource definition is static for the current ACP. Any suitable type of rules may be specified, for example, by a user, to define a dynamic set of resources. In general, a resource may be specified based on any suitable context, such creation, publication, annotation, interaction, and/or consumption. Context may also be defined in terms of one or more resource type(s), one or more user(s), one or more place(s), one or more time(s), etc. For example, a rule may define a particular resource type that was created by a specific user at a specific location. Any of the user rules described herein may also be applied to define resource rules.

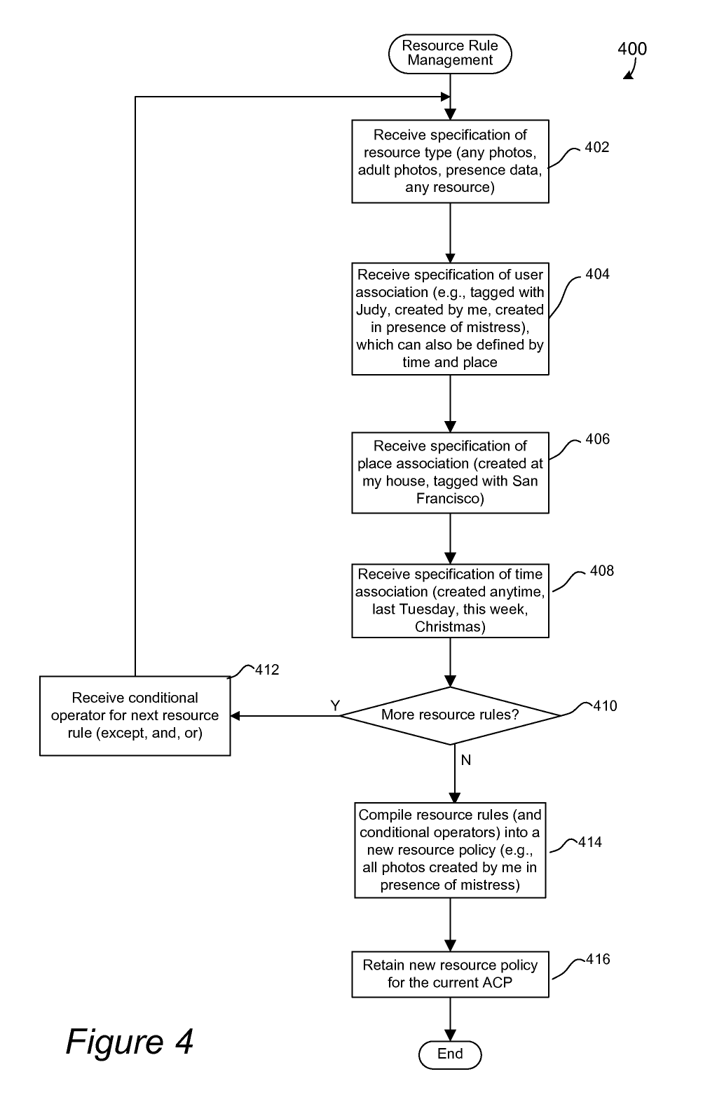

FIG. 4 is a flow chart illustrating a procedure 400 for managing dynamic resource rules in accordance with a specification implementation of the present invention. In the illustrated example, a specification of a resource type may be received in operation 402. For example, a specific category of resource (such as any photos, adult photos, presence data, any resource, etc.) may be specified by a user. A specified resource may take the form of a whole object (e.g., a document or photo) or a portion of an object (e.g., a document portion). In a topic rule example, a resource rule may specify a dynamic resource as “my photos that are tagged as ‘adult’”, while a membership rule specifies that such dynamic resource “is never public”

A specification of user association, which can also be defined by time and place, may also be received in operation 404. For instance, the dynamic set of resources may be defined as resources that are photographs and are tagged with a “Judy” tag. In other examples, the user association for a resource may include resources that are created by “me” or by a specified person, created in the presence of a specific person (e.g., my mistress Judy), etc. In a user association example, a resource rule may specify a dynamic resource as “photos taken with my mistress at home between 6 pm and 6 am and that are tagged ‘adult’”, while a membership rule specifies that this dynamic resource is “only available to me and my mistress.”

Specification of a place association (for the dynamic resource set) may also be received in operation 406. In specific location rule examples, a resource rule may define a dynamic resource as “photographs that were taken at my house” or “location logs that were generated when I'm within 500 feet of my house.” Specification of time association may also be received in operation 408. For example, resources that were created anytime, last Tuesday, this week, on Christmas day, next week, etc. may be defined as a dynamic resource set. In specific time rule examples, a resource rule may define a dynamic resource as “my presence data for the time period of 6 pm and 6 am”, while a corresponding membership rule specifies “no one can access” such dynamic resource.

It may be determined whether there are any more resource rules in operation 410. If there are more rules, a conditional operator for the next resource rule may also be received in operation 412. For example, the conditional operator may be in the form of a Boolean operator (e.g., except, and, or, not, etc.).

If there are no more rules, the rules and relationships may be compiled into a new resource policy in operation 414. The new dynamic resource policy may than be retained for the current ACP in operation 416. The resource rule management procedure 400 for the current ACP may then end. However, an authorized user may modify a particular resource policy of a particular ACP at any suitable time.

Protecting classes of resources in this manner allows for fewer accidental exposures of resources. For example, one cannot accidentally upload a photo with the wrong permissions or place a file in an unprotected directory. If the system has knowledge of the context of file creation or access or of the file content, existing rules can be automatically applied to protect that media or data. Additionally, resource rules could be learned by example and new permission settings suggested (e.g., other media about this topic, from this location, etc. is exposed only to people who were co-present at the time of media creation, create a rule?).

As illustrated, any suitable number and type of rules (e.g., for users and/or resources) may be defined for a particular ACP. In sum, an ACP may define a dynamic set of users who can access a particular resource or set of resources, which may also dynamically defined by the ACP. User access may include any suitable resource activities, such as read and/or write access for the resource itself or for the resource's associated ACP, etc. The policy or rules for a particular ACP can either be stored for later use or used immediately after such policy is defined. For instance, a user may define and then use an ACP as needed with respect to a particular resource or set of resources.

Referring back to the ACP management procedure of FIG. 2, it may also be determined whether a request to access a particular resource has been received in operation 214. When a request to access a particular resource is received, it may be determined whether the particular resource has an associated ACP in operation 216. If the resource has an associated ACP, it may be determined whether the requester is authorized based on the associated ACP in operation 218. In other words, it may be determined whether the requester meets the requirements of the associated one or more ACP's of the requested resource. For example, the list of members (or ACL) of the associated ACP may be compiled for the particular resource that is being requested. Alternatively, each resource's membership may be independently updated in any suitable manner, such as periodically updated or updated when trigger events occur (e.g., after any or a predetermined amount of new user information is collected or each time a new resource or a predefined number of resources is created).

Compilation of a dynamically defined resource's membership or ACL may include first determining which set of ACP's have resources rules that define the particular resource. For example, one or more ACP may have been set up to define different resource rule sets, and a particular resource may meet the specifications of one or more resource rule sets. After the applicable set of ACP's for the particular dynamic resource are found with respect to the resource rules of such ACP's, an ACL may be compiled from each found ACP and applied to the requester of the particular dynamic resource. Alternatively, such ACL's may be compiled periodically for each resource, rather than upon each resource request.

If a requester of a particular resource is authorized, the requester may then be allowed to access the particular resource (or resource's ACP) in operation 220. The requester may also be allowed to access the requested resource if there is not an associated ACP. Alternatively, a default policy may deny access to resources that do not have an associated ACP. If the requester is not authorized, the requester may then be denied access to the particular resource in operation 222. Denial of resource access may include denial of all rights to a resource or partial rights to a resource (e.g., deny write rights while allowing read). The procedure 200 may then repeat for any number of requesters and ACP managers.

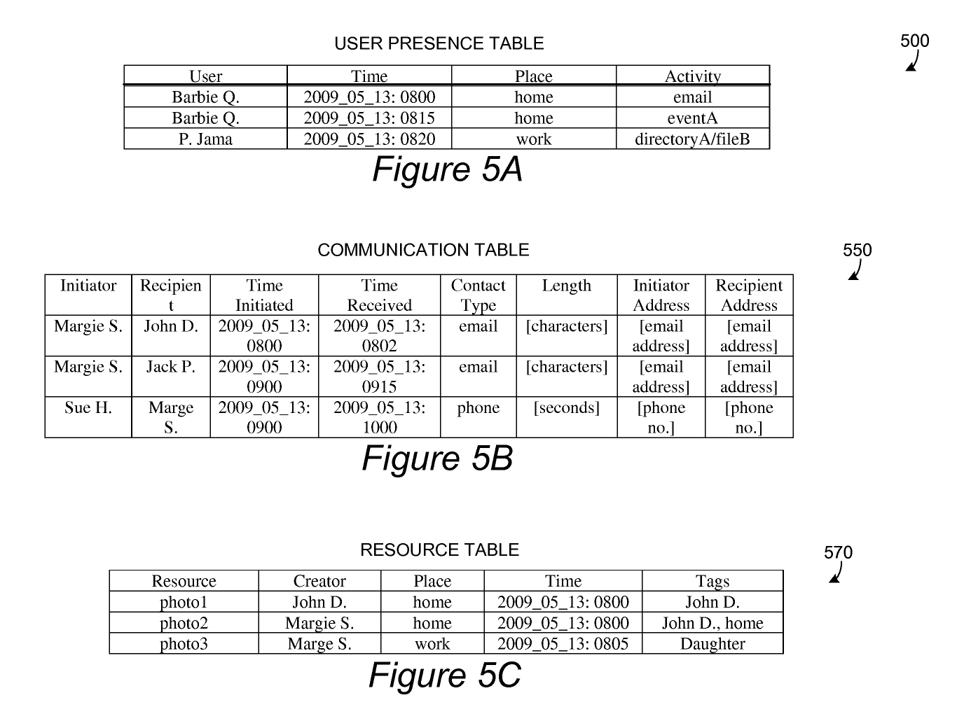

The user rules for a particular ACP (and the application of an ACP) may be based on any suitable user information, such as presence or communication data or any suitable resource information, which information can be stored in one or more databases (e.g., resource databases 115a or 115b). FIG. 5A illustrates a user presence table 500 in accordance with one embodiment of the present invention. As shown, each entry of the user presence table may include a user field for identifying a unique user, a time field for specifying a time and date, a place field for specifying a place at which the user was located for the specified time, and an optional activity field for specifying an activity in which the specified user was engaged during the specified time at the specified place. Alternatively, user activity information may be logged in other tables, such as a communication table.

FIG. 5B illustrates a communication table 550 in accordance with one embodiment of the present invention. Each entry in the communication table can specify details about a particular communication session between two or more users. As shown, each entry may include an initiator field that identifies the initiator of the communication session, a recipient field that identifies the recipient of the communication, a time initiated field, a time received field (e.g., when the email was opened), a contact type field (e.g., email, phone, IM, etc.), a length field (e.g., character count for email or text message, duration of phone call, etc), an initiator address field (e.g., phone number or email address), and a recipient address field (e.g., phone number or email address).

FIG. 5C illustrates a resource table 570 in accordance with one embodiment of the present invention. As shown, each entry of the resource table 570 includes a resource field for identifying a particular resource, a creator field for identifying who created the resource, a place field for optionally identifying a location (or a plurality of locations) associated with such resource, a time field for identifying a time associated with such resource, and a tag field for associating a text (or image) tag (or plurality of tags) with such resource. The resource field may specify a type of resource, such as photograph, video, audio, text file, etc. The resource field may also specify whole resources or portions of a resource. Sub-types (e.g., patent document, publication document, etc.) may also be specified. The place field may indicate where the resource was created or indicate place information within the content of such resource. For example, a place field may indicate that a photograph was taken in San Francisco or includes a person from San Francisco as a subject of such photograph. The other fields may also indicate contextual information regarding the creation or content of the associated resource. The physical location (e.g., file server or directory path) may also be specified for each resource. Any of these resource fields may also be dynamically defined. For example, a patent document type may be defined as a document type that includes the text “invention” more than 10 times.

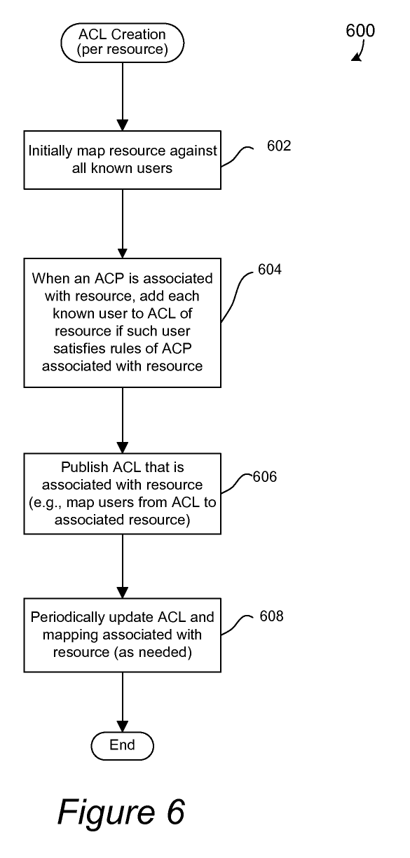

As described above, an ACL for a particular ACP and its associated resource (or set of resources) may be generated in any suitable manner. FIG. 6 is a flow chart illustrating a procedure 600 for creation of an ACL (with respect to each resource) in accordance with an alternative embodiment of the present invention. Initially, the resource may initially be mapped against all known users in operation 602. That is, any user may initially be able to access a particular resource until an ACL is defined for such resource. Alternatively, each resource may initially have a zero set ACL so that no users can initially access such resource until an ACP is created for such resource.

When an ACP is associated with the resource, each known user may then be added to the ACL of the resource if such user satisfies the rules of the ACP that is associated with the resource in operation 604. The ACL that is associated with the resource may then be published in operation 606. For example the users from the ACL may be mapped to the associated resource and such mapping may be retained in one or more databases. The ACL and mapping for the associated resource may also be periodically updated (as needed) in operation 608.

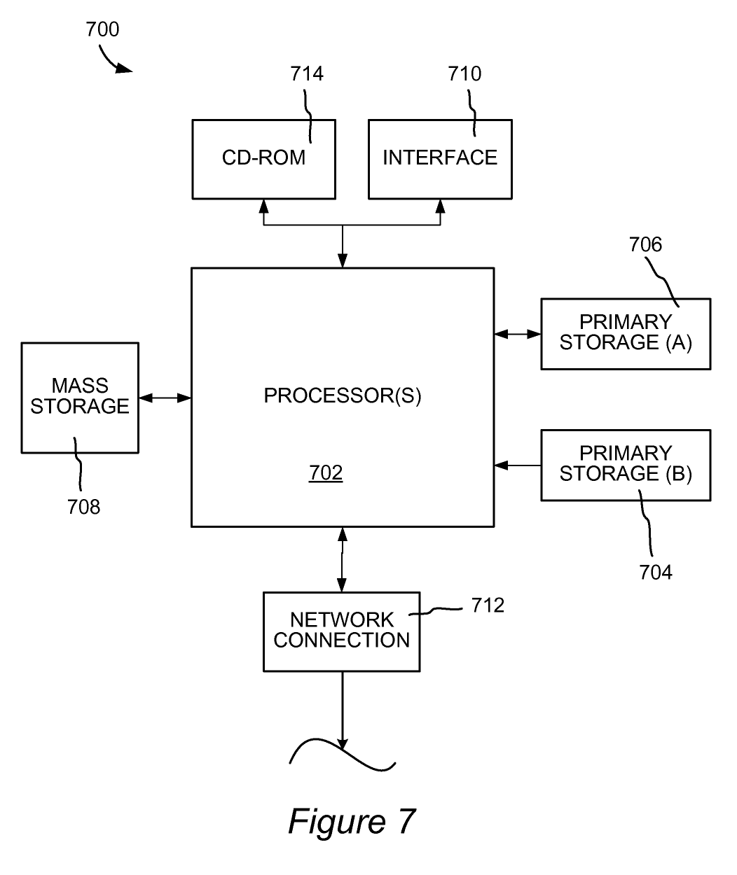

FIG. 7 illustrates a typical computer system that, when appropriately configured or designed, can serve as a dynamic ACL system. The computer system 700 includes any number of processors 702 (also referred to as central processing units, or CPUs) that are coupled to storage devices including primary storage 706 (typically a random access memory, or RAM), primary storage 704 (typically a read only memory, or ROM). CPU 702 may be of various types including microcontrollers and microprocessors such as programmable devices (e.g., CPLDs and FPGAs) and unprogrammable devices such as gate array ASICs or general-purpose microprocessors. As is well known in the art, primary storage 704 acts to transfer data and instructions uni-directionally to the CPU and primary storage 706 is used typically to transfer data and instructions in a bi-directional manner. Both of these primary storage devices may include any suitable computer-readable media such as those described herein. A mass storage device 708 is also coupled bi-directionally to CPU 702 and provides additional data storage capacity and may include any of the computer-readable media described herein. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 is also coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications network using an external connection as shown generally at 712. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store policy rules, user and resource information, membership lists, resources, etc.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method of creating or modifying a dynamic access control policy (ACP), comprising:
defining a current ACP for one or more specified resources based on one or more membership rules for specifying users who can access the one or more specified resources based on user information that was or will be collected for a plurality of users, wherein the collected user information includes at least user presence information or user communication data; and
retaining the current ACP for the one or more specified resources, wherein the current ACP is accessibly usable so as to dynamically allow a selected set of users, who each have corresponding collected user information which meets the one or more membership rules of the current ACP, to access the one or more specified resources,
wherein the selected set of users is changeable over time as different user information is collected over time.

2. The method of claim 1, wherein the one or more membership rules each specify one or more of the following: a user type, a user location, or a time, and wherein the one or more membership rules specify at least one conditional operator.

3. The method of claim 2, wherein the user type is specified by one or more other rules.

4. The method of claim 3, wherein the user type specifies a category of social relationship with respect to the first user.

5. The method of claim 1, wherein the specified resources are defined by one or more resources rules for specifying which selected set of resources is accessible based on the specified one or more membership rules of the current ACP, wherein the selected set of resources is changeable over time as different resources are created or modified over time.

6. The method of claim 5, wherein the one or more resource rules each pertain to one or more of the following contexts: creation, publication, annotation, interaction, or consumption, and the one or more resource rules each specify one or more of the following: a resource type, a location, a user, or a time, and wherein the one or more resource rules specify at least one conditional operator.

7. The method of claim 1, wherein the current ACP for the one or more specified resources is defined automatically based on one or more other ACP's for one or more other resources that have similar characteristics as the one or more specified resources.

8. An apparatus comprising at least a processor and a memory, wherein the processor and/or memory are configured to perform the following operations:
defining a current ACP for one or more specified resources based on one or more membership rules for specifying users who can access the one or more specified resources based on user information that was or will be collected for a plurality of users, wherein the collected user information includes at least user presence information or user communication data; and
retaining the current ACP for the one or more specified resources, wherein the current ACP is accessibly usable so as to dynamically allow a selected set of users, who each have corresponding collected user information which meets the one or more membership rules of the current ACP, to access the one or more specified resources,
wherein the selected set of users is changeable over time as different user information is collected over time.

9. The apparatus of claim 8, wherein the one or more membership rules each specify one or more of the following: a user type, a user location, or a time, and wherein the one or more membership rules specify at least one conditional operator.

10. The apparatus of claim 9, wherein the user type is specified by one or more other rules.

11. The apparatus of claim 10, wherein the user type specifies a category of social relationship with respect to the first user.

12. The apparatus of claim 8, wherein the specified resources are defined by one or more resources rules for specifying which selected set of resources is accessible based on the specified one or more membership rules of the current ACP, wherein the selected set of resources is changeable over time as different resources are created or modified over time.

13. The apparatus of claim 12, wherein the one or more resource rules each pertain to one or more of the following contexts: creation, publication, annotation, interaction, or consumption, and the one or more resource rules each specify one or more of the following: a resource type, a location, a user, or a time, and wherein the one or more resource rules specify at least one conditional operator.

14. The apparatus of claim 8, wherein the current ACP for the one or more specified resources is defined automatically based on one or more other ACP's for one or more other resources that have similar characteristics as the one or more specified resources.

15. At least one computer readable storage medium having computer program instructions stored thereon that are arranged to perform the following operations:
defining a current ACP for one or more specified resources based on one or more membership rules for specifying users who can access the one or more specified resources based on user information that was or will be collected for a plurality of users, wherein the collected user information includes at least user presence information or user communication data; and
retaining the current ACP for the one or more specified resources, wherein the current ACP is accessibly usable so as to dynamically allow a selected set of users, who each have corresponding collected user information which meets the one or more membership rules of the current ACP, to access the one or more specified resources,
wherein the selected set of users is changeable over time as different user information is collected over time.

16. The at least one computer readable storage medium of claim 15, wherein the one or more membership rules each specify one or more of the following: a user type, a user location, or a time, and wherein the one or more membership rules specify at least one conditional operator.

17. The at least one computer readable storage medium of claim 16, wherein the user type is specified by one or more other rules.

18. The at least one computer readable storage medium of claim 17, wherein the user type specifies a category of social relationship with respect to the first user.

19. The at least one computer readable storage medium of claim 15, wherein the specified resources are defined by one or more resources rules for specifying which selected set of resources is accessible based on the specified one or more membership rules of the current ACP, wherein the selected set of resources is changeable over time as different resources are created or modified over time.

20. The at least one computer readable storage medium of claim 19, wherein the one or more resource rules each pertain to one or more of the following contexts: creation, publication, annotation, interaction, or consumption, and the one or more resource rules each specify one or more of the following: a resource type, a location, a user, or a time, and wherein the one or more resource rules specify at least one conditional operator.

21. The at least one computer readable storage medium of claim 15, wherein the current ACP for the one or more specified resources is defined automatically based on one or more other ACP's for one or more other resources that have similar characteristics as the one or more specified resources.
